(19) United States
(12) Patent Application Publication
(10) Pub. No.: US 2017/0304776 A1
(43) Pub. Date: Oct. 26, 2017

(54) FILTER CORE STRUCTURE HAVING FLOW GUIDING AND FLUSHING CAPABILITIES

(71) Applicant: Xiamen Runner Industrial Corporation, Xiamen (CN)

(72) Inventors: XIAN-LIANG GUO, Xiamen (CN); JIAN-YONG YAN, Xiamen (CN)

(21) Appl. No.: 15/479,265

(22) Filed: Apr. 4, 2017

(30) Foreign Application Priority Data
Apr. 21, 2016 (CN) 201620340058.5

(51) Int. Cl. B01D 65/02; B01D 61/14; C02F 1/44

(52) U.S. Cl. CPC B01D 65/02; C02F 1/444; B01D 61/145; C02F 2307/10; C02F 2303/16

(57) ABSTRACT

A filtering core structure having flow guiding and flushing capabilities includes: a wall piece; a filter bottle, disposed on the wall piece, with a top portion of the filter bottle provided with a water input port and a clean water port; a filter core, disposed in the filter bottle, such that water output end of filter core is connected to and in communication with the clean water port; a water input chamber, disposed inside the filter bottle and around perimeter of the filter core; and a flow guiding tube, connected to water input port, and in communication with bottom portion of the water input chamber. In this filter core structure, thrust of water flow is used to flush germs and impurities from the bottom of filter bottle, so that stagnant water will not remain there, in solving the problem of germ multiplication and stinky water.

### BACKGROUND OF THE INVENTION

### Field of the Invention

The present invention relates to a filter core structure, and in particular to a filter core structure having flow guiding and flushing capabilities.

### The Prior Arts

Presently, the ultrafiltration membrane filter core utilized in a water purifier is very effective in filtering and thus gathering large amount of germs, particles, and impurities. The disadvantage of this type of filter core is that, when they are not in use for a long period of time, the germs staying at the bottom of the filter bottle tend to multiply in large quantity, to cause the water purifier to stink and give out a very foul smell, thus leading to the dissatisfaction and complaint of the user.

Therefore, presently, the design and performance of the water purifier filter core is not quite satisfactory, and it leaves much room for improvement.

### SUMMARY OF THE INVENTION

In view of the problems and drawbacks of the prior art, the present invention provides a filter core structure having flow guiding and flushing capabilities, to overcome the shortcomings of the prior art concerning germs multiplication and stinky smell of purified water.

The present invention provides a filtering core structure having flow guiding and flushing capabilities, that includes: a wall piece, a filter bottle, a filter core, a water input chamber, and a flow guiding tube.

The filter bottle is disposed on the wall piece, with a top portion of the filter bottle provided with a water input port and a clean water port. The filter core is disposed in the filter bottle, such that a water output end of the filter core is connected to and in communication with the clean water port. The water input chamber is disposed inside the filter bottle and around perimeter of the filter core. The flow guiding tube is connected to the water input port, and in communication with a bottom portion of the water input chamber.

In an aspect of the present invention, the filtering core structure having flow guiding and flushing capabilities further includes: a waste water output port, disposed on the top portion of the filter bottle and in communication with the water input chamber.

In another aspect of the present invention, the filtering core structure having flow guiding and flushing capabilities further includes: a water input tube, disposed on the wall piece, and connected to and in communication with the water input port; a clean water output tube, connected to and in communication with the clean water port; a waste water output tube, connected to and in communication with the waste water output port; and a control valve, disposed on the waste water output tube.

In a further aspect of the present invention, the filter bottle includes a bottle body, having an opening at its bottom portion; and a bottom seat, disposed on the opening at the bottom portion of the bottle body.

Compared with the existing technology, the present invention has the advantage in that, in the present invention, the thrust of water flow is used to flush the germs and impurities away from the bottom of the filter bottle, in solving the problem of germs multiplication and bad smell of the purified water.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a water purifier according to the Prior Art;

FIG. 2 is a schematic diagram of a water purifier containing a filter core structure having flow guiding and flushing capabilities according to an embodiment of the present invention; and

FIG. 3 is a cross section view of a water purifier containing a filter core structure having flow guiding and flushing capabilities according to an embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

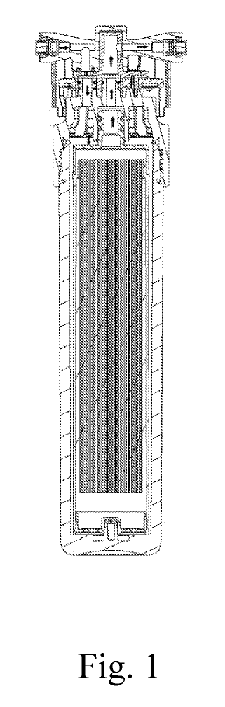

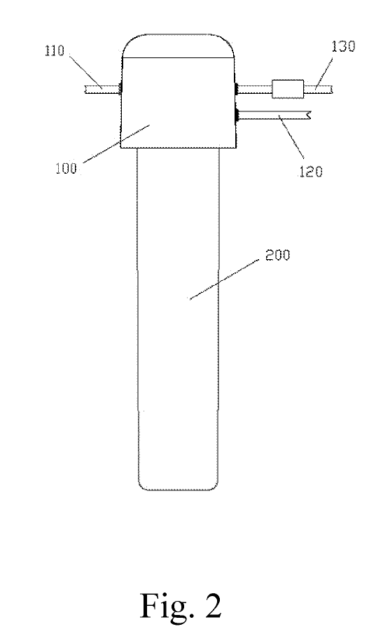

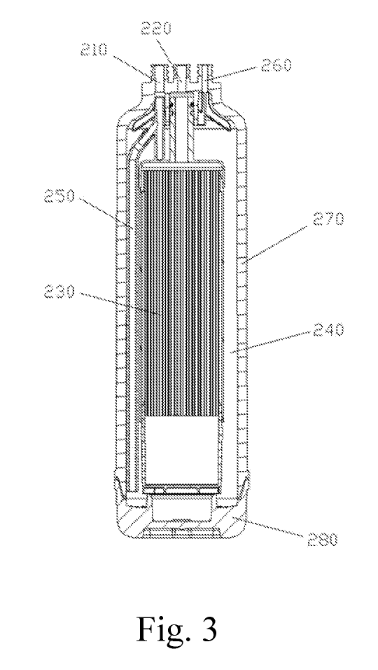

Refer to FIGS. 1 to 3 respectively for a schematic diagram of a water purifier according to the Prior Art; a schematic diagram of a water purifier containing a filter core structure having flow guiding and flushing capabilities according to an embodiment of the present invention; and a cross section view of a water purifier containing a filter core structure having flow guiding and flushing capabilities according to an embodiment of the present invention.

As shown in FIGS. 1 to 3, the present invention provides a filtering core structure having flow guiding and flushing capabilities, that includes: a wall piece 100, a filter bottle 200, a filter core 230, a water input chamber 240, and a flow guiding tube 250.

The filter bottle 200 is disposed on the wall piece 100, with a top portion of the filter bottle 200 provided with a water input port 210 and a clean water port 220. The filter core 230 is an ultra-filtration membrane filter core disposed in the filter bottle 200, such that a water output end of the filter core 230 is connected to and in communication with the clean water port 220. The water input chamber 240 is disposed inside the filter bottle 200 and around perimeter of the filter core 230. The flow guiding tube 250 is connected to the water input port 210, and in communication with a bottom portion of the water input chamber 240. In operation, water flows in from the water input port 210, then it is guided by the flow guiding tube 250 to flow directly to the bottom of the filter bottle 200. As such, germs and impurities are flushed out from the bottom of the filter bottle 200 through the thrust of water flow, so that stagnant water will not remain there.

In an embodiment of the present invention, the filtering core structure having flow guiding and flushing capabilities further includes: a waste water output port 260, disposed on the top portion of the filter bottle 200 and in communication with the water input chamber 240. For every time interval, water in the filter bottle 200 will be exited through the waste water output port 260, to exit the germs and the impurities, in solving the problem of germ multiplication and stinky water.

In an embodiment of the present invention, the filtering core structure having flow guiding and flushing capabilities further includes: a water input tube 110, disposed on the wall piece 100, and connected to and in communication with the water input port 210; a clean water output tube 120, connected to and in communication with the clean water port 220; a waste water output tube 130, connected to and in communication with the waste water output port 260; and a control valve 131, disposed on the waste water output tube 130. The control valve 131 can be an electromagnetic valve controlled and operated automatically, or a ball valve controlled and operated manually.

In an embodiment of the present invention, the filter bottle 200 includes a bottle body 270, having an opening at its bottom portion; and a bottom seat 280, disposed on the opening at the bottom portion of the bottle body 270. The bottle body 270 and the bottom seat 280 are disposed to form into tight seal cooperation.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A filtering core structure having flow guiding and flushing capabilities, comprising:
a wall piece;
a filter bottle, disposed on the wall piece, with a top portion of the filter bottle provided with a water input port and a clean water port;
a filter core, disposed in the filter bottle, such that a water output end of the filter core is connected to and in communication with the clean water port;
a water input chamber, disposed inside the filter bottle and around perimeter of the filter core; and
a flow guiding tube, connected to the water input port, and in communication with a bottom portion of the water input chamber.

2. The filtering core structure having flow guiding and flushing capabilities as claimed in claim 1, further comprising: a waste water output port, disposed on the top portion of the filter bottle and in communication with the water input chamber.

3. The filtering core structure having flow guiding and flushing capabilities as claimed in claim 2, further comprising:
a water input tube, disposed on the wall piece, and connected to and in communication with the water input port;
a clean water output tube, connected to and in communication with the clean water port;
a waste water output tube, connected to and in communication with the waste water output port; and
a control valve, disposed on the waste water output tube.

4. The filtering core structure having flow guiding and flushing capabilities as claimed in claim 1, wherein the filter bottle includes a bottle body, having an opening at its bottom portion; and a bottom seat, disposed on the opening at the bottom portion of the bottle body.
